(19) United States
(12) Patent Application Publication
(10) Pub. No.: US 2009/0013585 A1
(43) Pub. Date: Jan. 15, 2009

(54) Split shot

(76) Inventors: Arthur Keith Acworth, Cleveland Brisbane Queensland (AU); Alexander Stuart Gordon Corrie, Balmoral Brisbane Queensland (AU)

Correspondence Address: MCDERMOTT, WILL & EMERY LLP, 227 WEST MONROE STREET, SUITE 4400, CHICAGO, IL, 60606-5096, US

(21) Appl. No.: 11/827,948

(22) Filed: Jul. 13, 2007

(51) Int. Cl. A01K 95/00

(52) U.S. Cl. 43/44.89; 43/44.91

(57) ABSTRACT

The invention provides a fishing sinker, which is easily attached to and removed from a fishing line. The sinker includes a body constructed of a degradable material having an opening into which a fishing line is placed. The fishing line is secured within the opening using a pliable material.

### CROSS-REFERENCE TO RELATED APPLICATIONS

Not Applicable

### FEDERALLY SPONSORED RESEARCH OR DEVELOPMENT

Not Applicable.

### TECHNICAL FIELD

The present application relates to weights and sinkers for fishing, and more specifically to a degradable sinker having an opening for receiving a fishing line and filled with binding material for securing the fishing line.

### BACKGROUND OF THE INVENTION

Split type shot sinkers are well known. Traditionally, sinkers are made of lead, wherein the fishing line is placed within a groove found in the sinker. The sinker is then clamped together either by hand or through using a pair of pliers, securing the sinker on the fishing line. Multiple sinkers can be applied to the line, depending on the conditions and desired depth of the line holding bait or a lure. Use of lead sinkers was inexpensive, the pliability offered by lead sinkers made them convenient for application and removal of the sinkers to fishing lines.

In recent years, however, the use of lead in the manufacture of weights and sinkers has become less desirable because of the environmental impact of lead sinkers lost during use, littering the beds of fish habitats, and negatively affecting waterfowl. Further, handling of lead sinkers is likewise undesirable in view of health concerns and lead exposure. Lead, however, makes application and removal of the typical fishing sinker convenient. Yet, environmental pressures and possible legislation banning lead sinkers are driving toward alternative materials for construction of fishing weights and sinkers. The present invention aims to provide the same convenience of application and reusability afforded by lead sinkers in a sinker constructed of a material more desirable for the environment should the sinker be lost. Therefore, an advantage of the present invention is that it can be made from degradable or biodegradable materials, without losing the ease of use and application afford by a lead sinker.

### SUMMARY OF THE INVENTION

The present invention generally provides fishing sinker with a body having a defined outer shape and an opening extending axially through the body, wherein the opening is adapted for receiving a fishing line. A plug is used for securing the line within the opening. The shape of the body can be a round, egg-shaped or tapered cylinder shape.

According to one aspect of the present invention, the opening is a linear opening extending axially through the body. The fishing line is placed within the linear opening and secured by placement of a pliable binding material in the opening.

According to another aspect of the present invention, the opening is an irregular or zigzag shape. The fishing line is placed within the opening and held in place through a combination of friction created by the irregular opening and the placement of a pliable binding material within the opening.

According to another aspect of the invention, the opening is a smooth “S” or serpentine shape. Fishing line is held within in the opening though friction and placement of a pliable binding material within the opening.

According to yet another aspect of the present invention, fish attractant may be included in the pliable binding material.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of the fishing sinker;

FIG. 2 is a top view of a first embodiment of the sinker;

FIG. 3 is a side view of a first embodiment of the sinker;

FIG. 4 is a second side view of the first embodiment of the sinker;

FIG. 5 is a cross sectional view of the first embodiment of the sinker taken along lines A-A in FIG. 1;

FIG. 6 is a top view of a second embodiment of the sinker;

FIG. 7 is a top view of a third embodiment of the sinker;

FIG. 8 is a top view of a fourth embodiment of the sinker;

FIG. 9 is a top view of a fifth embodiment of the sinker.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring now to the Figures, there is shown various embodiments of the fishing sinker 10. The sinker 10 generally comprises a body 12 having a defined outer shape and an opening 14 extending axially through the body, wherein the opening is adapted for receiving a fishing line 16. A plug 18 made of a pliable binding material is used for securing the line 16 within the opening 14. The sinkers 10 described herein are convenient for placement and removal on a fishing line 16, and are constructed from and use degradable materials. One advantage of the present invention is that should the sinker be lost, it will degrade so as to not contaminate the surrounding environment. The body can any size and shape suitable for fishing, including round, egg-shaped or tapered cylinder shape.

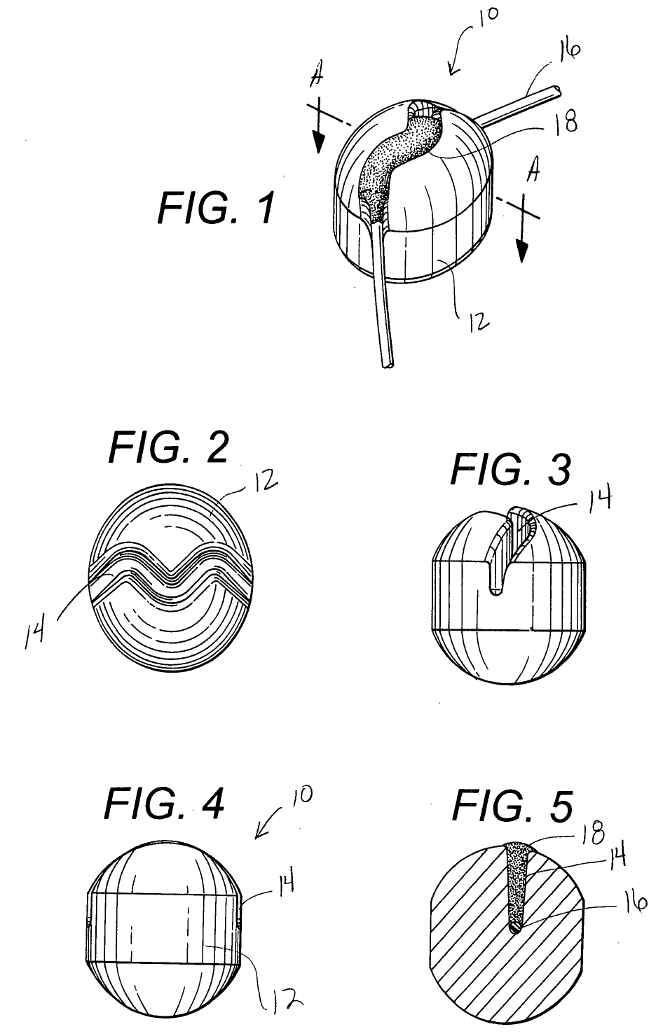

As shown in FIG. 1, one embodiment of the invention, the sinker 10 comprises a body 12 opening is a linear opening 14 extending axially through the body. The fishing line 16 is placed in the opening 14 by the user, who then secures the line by placement of a pliable material into the opening securing the line within the opening. The body 12 can be of any suitable shape or size for a fishing sinker, but preferably has a round or spherical shape.

The body 12 is constructed from a degradable, biodegradable or non-toxic material including steel, and preferably a compressed metal powder. The sinker body can be constructed through either forging steel blanks into the desired shapes, cast from steel or iron, or folded or formed from blanks about a mandrel or in such a manner that the linear opening remains through the formed body.

Preferably the body 12 is formed from a non-toxic metal powder, which may be ferrous or non-ferrous metal powder. Advantageously, the body 12 is formed from a non-toxic material, such as a compressed iron powder that degrades upon long term exposure to water, should the sinker be lost. More preferably, the body 12 is constructed of an iron powder containing a lubricant such as zinc stearate that is sintered at least to some extent to increase its resistance to breakage upon impact. Sinkers of the type useful in the present invention can be constructed according to compositions and methods such as those in U.S. Pat. No. 6,497,069, which is incorporated by reference herein.

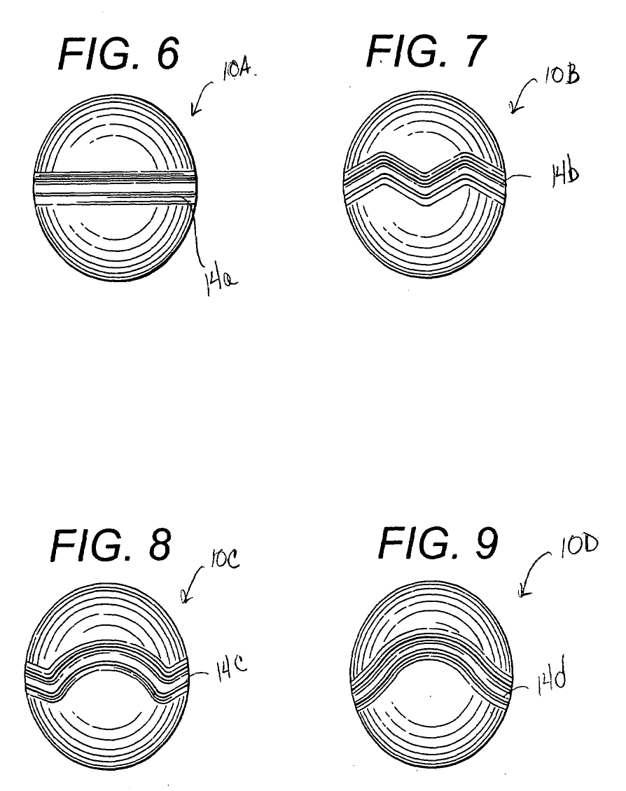

Located axially thorough the body 12 is an opening 14 for receiving the fishing line. As shown in FIG. 1 the opening 14 has an uneven or zigzag shape. The corners provided by this zigzag shape of opening 14 provide friction for the fishing line 16, preferably lessening the slide of the fishing line when it is placed in the opening, thereby further securing the line within the opening 14. The opening 14 can have any depth suitable for receiving the fishing line and pliable material, and is preferably about half the depth of the body 12. FIGS. 7 through 9 show alternative embodiments for the shape of the opening, 14a, 14b, 14c and 14d, all of which are suitable for use in the present invention.

As shown in FIG. 1 and the cross section of FIG. 5, in use, the fishing line 16 is placed within the opening 14 of the sinker 10. The fishing line 16 is secured within the opening 14 by placement of a plug 18 made of pliable material, which is positioned within the opening and on top of the fishing line 16. Pliable materials suitable for use in the present invention include any malleable material such as wax, rubber, or cork. Ideally, the material should be easy to manipulate with finger pressure. Preferably, the pliable material is made of a natural, non-toxic, degradable or biodegradable material, such as beeswax. Alternatively, the pliable material can include a fish attractant, also preferably of a natural, non-toxic composition.

When the day of fishing is complete, the plug 18 can be removed from the opening 14, and the sinker removed from the fishing line 16. The sinker 10 can be reused at another time. However, even if the sinker 10 is lost during fishing, it will degrade rather quickly without contaminating the surrounding environment. Alternatively, lost sinkers may be recovered using magnetic recovery techniques.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A fishing sinker comprising:
a body having a defined outer shape;
an opening extending axially through the body, wherein the opening is adapted for receiving a fishing line;
a plug for securing the line within the opening.

2. The fishing sinker of claim 1 wherein the body has a cylindrical shape.

3. The fishing sinker of claim 1, wherein the body is constructed of non-toxic degradable material.

4. The fishing sinker of claim 1, wherein the body is constructed of a compressed iron powder.

5. The fishing sinker of claim 1, wherein the opening has a depth and a width sufficient for receiving the fishing line.

6. The fishing sinker of claim 1, wherein the opening has a zigzag shape.

7. The fishing sinker of claim 1 wherein in the opening has an “S” shape.

8. The fishing sinker of claim 1 wherein the plug for securing the line within the opening a pliable binding material.

9. The fishing sinker of claim 10, wherein the pliable binding material is degradable.

10. The fishing sinker of claim 9 wherein the pliable binding material further includes a fish attractant.

11. A fishing sinker comprising:
a body of compressed metal powder having a defined outer shape;
an “S” shaped opening disposed through the body, the opening being provided for receiving a fishing line;
a degradable pliable plug material disposed within the opening for securing the fishing line within the opening.

12. A fishing sinker comprising:
a body of compressed metal powder having a defined outer shape;
a zigzag shaped opening disposed through the body, the opening being provided for receiving a fishing line;
a degradable pliable plug material disposed within the opening for securing the fishing line within the opening.
